(19) United States
(12) Patent Application Publication
(10) Pub. No.: US 2009/0140188 A1
(43) Pub. Date: Jun. 4, 2009

(54) ENERGY EFFICIENT SOLENOID FOR MECHANICALLY ACTUATING A MOVABLE MEMBER

(75) Inventors: Ross KUNZ, Fergus Falls, MN (US); Robert Kunz, Fergus Falls, MN (US); Dominic Kunz, Fergus Falls, MN (US)

Correspondence Address: OBLON, SPIVAK, MCCLELLAND MAIER & NEUSTADT, P.C., 1940 DUKE STREET, ALEXANDRIA, VA, 22314, US

(73) Assignee: STONEL CORPORATION, Fergus Falls, MN (US)

(21) Appl. No.: 12/033,676

(22) Filed: Feb. 19, 2008

Related U.S. Application Data
(63) Continuation-in-part of application No. 11/949,436, filed on Dec. 3, 2007.

(51) Int. Cl. F16K 31/02; H01F 7/08

(52) U.S. Cl. 251/129.15; 335/256

(57) ABSTRACT

A solenoid actuator includes an electrical circuit with a first power input terminal, a second power input terminal, a first coil wound around a first axis and configured to generate a first magnetic field while electrical current flows through the first coil, and a second coil wound around a second axis configured to generate a second magnetic field while electrical current flows through the second coil. An electric switch connects or disconnects the first coil and second coil in series or parallel. Thus, the electric switch can energize or de-energize the second coil. A movable member, such as a rod, bar, spool, or hollow tube, influenced by the magnetic fields generated by the first and second coils is configured to move with respect to the first and second coils from a first position to a second position in response to the magnetic field generated by the first coil.

### CROSS-REFERENCE TO RELATED APPLICATIONS

This application is a continuation-in-part of and claims the benefit of priority under 35 U.S.C. §120 from U.S. Ser. No. 11/949,436 filed Dec. 3, 2007, and the entire contents of which are incorporated herein by reference.

### BACKGROUND OF THE INVENTION

1. Field of the Invention

This invention relates to an energy efficient solenoid device. One application of the invention is to move a movable member from a first position to a second position. In one example, the invention relates to an energy efficient solenoid coupled to a valve such as a ball valve, spool valve, plug valve, or needle valve.

2. Description of the Related Art

Solenoids are typically used to convert electrical energy into mechanical energy to shift position of a movable mechanical member, for example, a plunger or needle in a needle valve.

An alternative technology used to turn electrical energy into mechanical energy is a piezoelectric device. These devices are often used for sonic transducers and small motors such as those used for focusing cameras. However, piezoelectric devices can fail in a frozen or “stuck” position, which is undesirable for mechanisms requiring a fail-safe design. Piezoelectric devices are typically more expensive than solenoids used for comparable applications. Solenoids typically are more easily made to fail in a safe position than are piezoelectric devices.

Solenoids typically include an electrically conductive wire that is circularly wound through a number of turns in the form of a coil. A magnetically conductive rod is disposed inside the wound coil. As current passes through the coil, a magnetic field is generated and causes the conductive rod to move relative to the coil from a first position to a second position. In some applications, a biasing member such as a spring forces the rod to return to the first position when the current ceases to flow through the coil.

One common application of a solenoid is in an electronic door lock such as those commonly used in remotely controlled security doors. When a user pushes a button connected to a solenoid coupled to the door lock, the button connects the coiled wire to a power source, thereby creating a magnetic field within the coiled wire. This field causes a magnetically conductive plunger to move into or out of a locking position. After the button has been released, a biasing member, such as a spring, returns the plunger to its original position. Accordingly, the force generated by the coil must be greater than the amount of biasing force generated by the spring. Generally, two levels of force are required of the coil. First, the coil must generate enough force to shift the plunger from the first position to the second position. The force required to move the plunger from the first position to the second position is called the “shifting” force. Second, the coil must be able to generate enough force to hold the plunger in the second position. This is called the “holding” force. Generally, the electrical power required to produce the shifting force is greater than the electrical power required to produce the holding force. The difference in power required to produce the shifting force is due to the air gap, friction and possible resistance from fluid or components in contact with the plunger.

Often, an important factor in determining the components to be used in the solenoid is the cost of the component themselves. In other situations, power consumption is a more important factor. Power consumption generally correlates to the amount of heat generated by the solenoid.

In situations where either low heat or low power consumption are a concern, it is preferable to reduce the amount of current used to generate the holding force. This is because solenoids typically spend much more time with the plunger in the second position, in which the coil generates a holding force, than the solenoids spend actually shifting, during which the coil generates the shifting force.

### SUMMARY OF THE INVENTION

One aspect of the present invention is to provide an energy efficient solenoid that provides an appropriate amount of electrical energy with the force required to shift a solenoid and an appropriate amount of energy to hold a solenoid in position once the solenoid has shifted.

Accordingly, one aspect of the present invention provides a solenoid actuator including an electric circuit with a first power input terminal and a second power input terminal. The circuit further includes a first coil wound around a first axis and configured to generate a first magnetic field while electric current flows through the first coil. A second coil wound around a second axis is configured to generate a second magnetic field while electric current flows through the second coil. The first and second coils can have the same axis or have different axes, i.e., the first and second axes can be collinear, offset and parallel, or at an angle to each other. An electric switch is configured to switch from a first state in which the first coil is connected in series with the first and second power input terminals without being connected in series with the second coil, to a second state in which the first coil is connected in series with the second coil. Thus, the electric switch can energize or de-energize the second coil. A movable member, such as a rod, bar, spool, or hollow tube, influenced by the first and second magnetic fields generated by the first coil and the second coil is configured to move with respect to the first and second coils from a first position to a second position in response to the magnetic field generated by the first coil. In one example, the movable member moves in a direction parallel to one of the first and second axes.

Another aspect of the present invention provides an automatic valve, which can include a standard valve such as a 3-way air valve and electric circuitry for operation of the 3-way air valve. The circuitry includes a solenoid disposed within or connected to the valve. The solenoid includes an electric circuit with a first power input terminal and a second power input terminal. The solenoid further includes a first coil wound around a first axis and configured to generate a first magnetic field while electric current flows through the first coil and a second coil wound around a second axis and configured to generate a second magnetic field while electric current flows through the second coil. The solenoid further includes an electric switch configured to switch from a first state in which the first coil is connected in series with the first and second power input terminals without being connected in series with the second coil, to a second state in which the first coil is connected in series with the second coil. Additionally, the solenoid includes means for controlling time at which the electric switch changes state. The solenoid includes a movable member influenced by the first and second magnetic fields generated by the first coil and the second coil and configured to move with respect to the first and second coils from a first position to a second position in response to the magnetic field generated by the first coil.

Another aspect of the invention includes a method of actuating a solenoid. The method includes providing a first coil and second coil. The method further includes electrifying the first coil with a first electric current such that a first magnetic field generated by the first coil during electrification moves the movable member from a first position to a second position. The method includes changing a state of a switch connected between the first coil and second coil such that a second electric current, different from the first electric current, flows in series connection through the first and second coils and generates a second magnetic field in the second coil that holds the movable member in the second position.

### BRIEF DESCRIPTION OF THE DRAWINGS

These and other advantages of the invention will become more apparent and more readily appreciated from the following detailed description of the exemplary embodiments of the invention taken in conjunction with the accompanying drawings where:

FIG. 1 is a schematic representation of a solenoid valve with a spring return mechanism;

FIG. 2A depicts one example, in cross-section, of a solenoid including a rod internal to two coils;

FIG. 2B depicts another example, in cross-section, of a solenoid including two coils overlapping each other;

FIG. 2C depicts another embodiment of the invention in which the solenoid moves a movable bar;

FIG. 3 is an electrical schematic representing one example of the inventive solenoid with an electronic switch in a first position, typically used for shifting a mechanical member from a first position to a second position;

FIG. 4 is an electrical schematic representing one example of the inventive solenoid with an electronic switch in a second position, typically used for holding the mechanical member in the second position against the biasing force of the biasing member;

FIG. 5 is an electrical schematic representing another example of the inventive solenoid with an electronic switch in a first position, typically used for shifting a mechanical member from a first position to a second position;

FIG. 6 is an electrical schematic representing one example of the inventive solenoid depicted in FIG. 5 with an electronic switch in a second position, typically used for holding the mechanical member in the second position against the biasing force of the biasing member;

FIG. 7 is an electrical schematic representing yet another example of the inventive solenoid with an electronic switch in a first position, typically used for shifting a mechanical member from a first position to a second position; and

FIG. 8 is an electrical schematic representing one example of the inventive solenoid depicted in FIG. 7 with an electronic switch in a second position, typically used for holding the mechanical member in the second position against the biasing force of the biasing member.

### DETAILED DESCRIPTION OF THE PREFERRED EMBODIMENTS

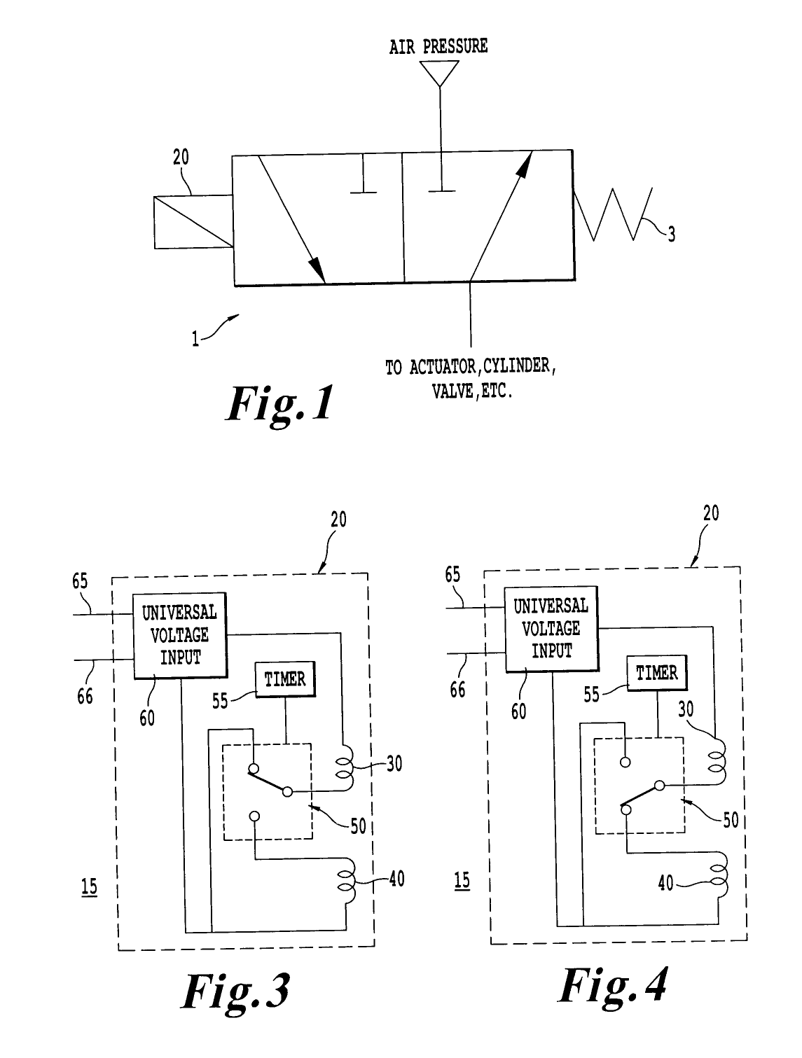

With reference to FIG. 1, one example of an application of a solenoid is in a valve such as the spring-return 3-way valve 1, which includes a solenoid 20 for shifting the valve from a first position to a second position. When the solenoid 20 is not energized, the 3-way valve 1 is in the first position. When the solenoid 20 is energized, the 3-way valve 1 moves to the second position in response to a shifting force generated by the solenoid 20. Once the 3-way valve 1 is in the second position, the solenoid 20 must maintain sufficient force, i.e., a “holding force,” to hold the 3-way valve 1 in place against the force produced by the valve spring 3, which functions as a biasing member. When current ceases to flow through the solenoid 20, the solenoid 20 ceases to generate force, and the valve spring 3 causes the 3-way valve 1 to move back to the first position.

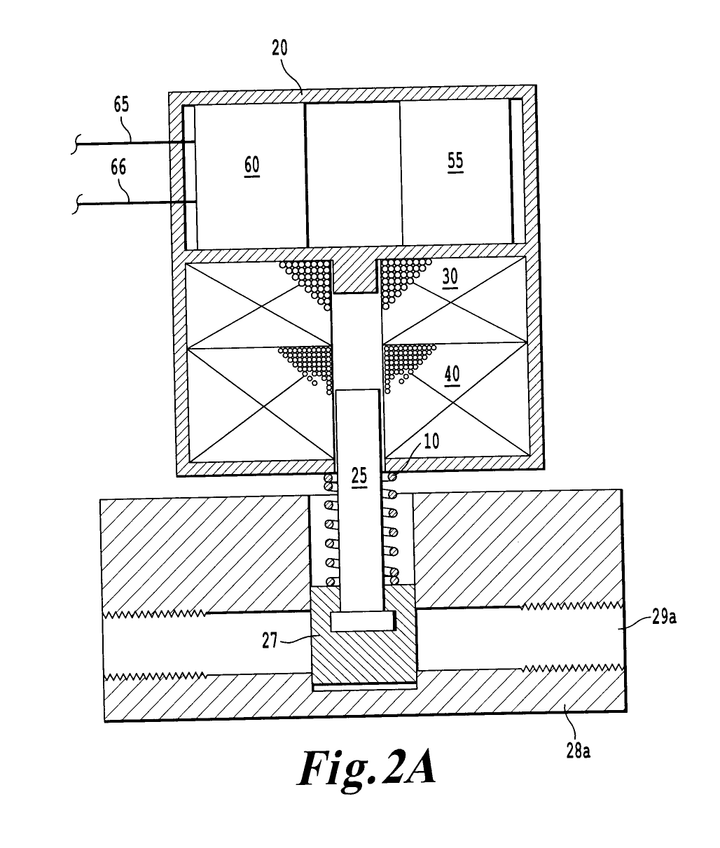

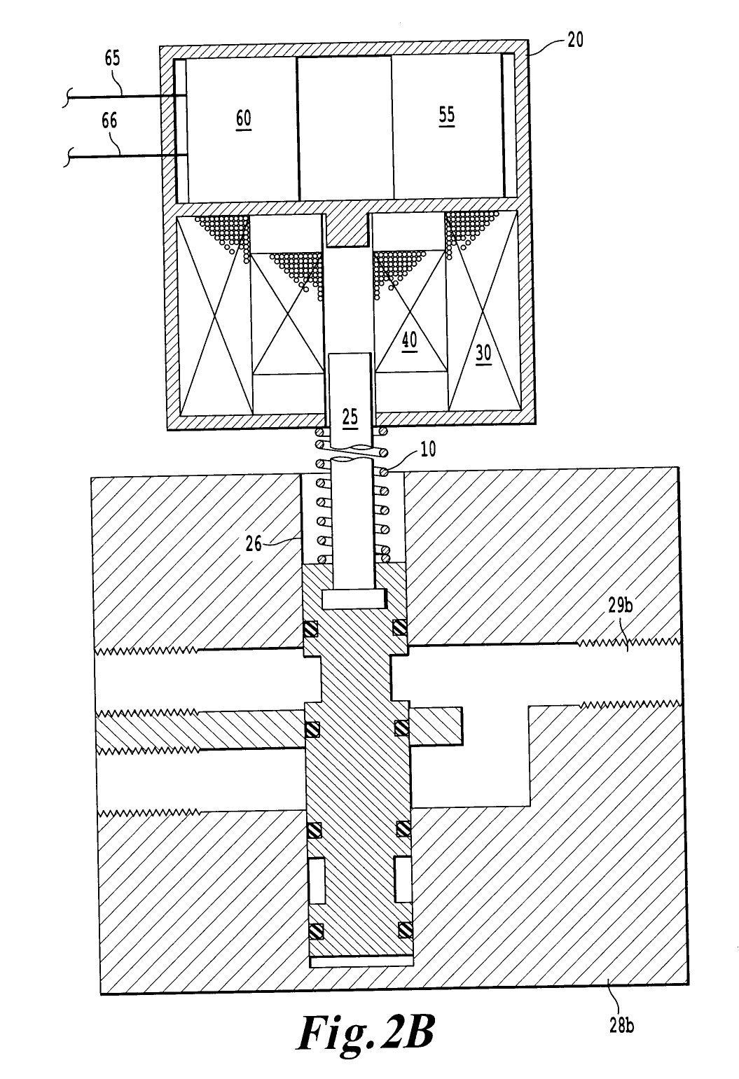

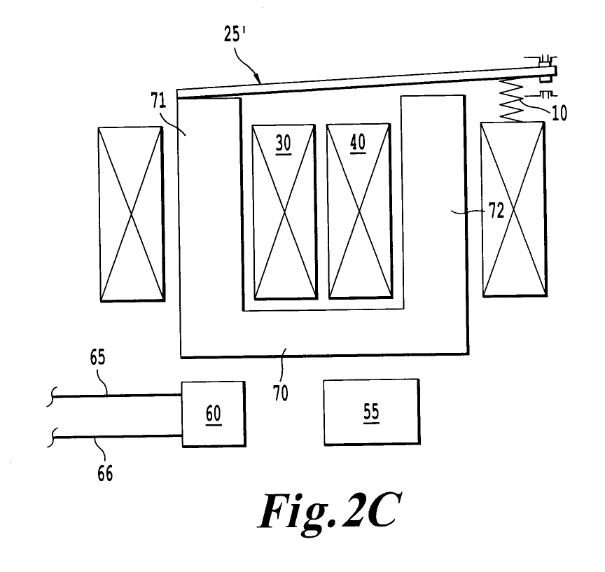

FIG. 2A is a cross-section view of one example of a solenoid 20 as may be used in combination with the 3-way valve 1. The solenoid 20 includes a shift coil 30 and hold coil 40 disposed around a rod 25. In the example shown in FIG. 2, the rod 25 is connected to a spring 10, which biases the rod toward a first position. The spring 10 may be included in the solenoid 20, or the spring 10 may be omitted, depending on whether the rod 25 is to be internally biased (as shown in FIG. 2A), externally biased (as shown by the valve spring 3 in FIG. 1), or unbiased. The rod 25 typically moves axially along its longitudinal axis in and out of the solenoid 20 in response to electrification of the shift coil 30. Movement of the rod 25 causes a spool 26 (shown in FIG. 2B) to move within a fluid passageway 29b in a valve 28b to connect various fluid passageways. Alternatively, the spool 26 can be replaced with a plunger 27 (shown in FIG. 2A) that opens or blocks a fluid passageway 29a in a valve 28a. In other embodiments, the rod 25 moves other devices unrelated to valves. For example, rod 25 or other component moved by the shift coil 30 can be used to cause an electrical switch to change state, i.e., an electrical relay.

In FIG. 2A, the solenoid 20 is shown with the shift coil 30 disposed completely separated in an axial direction from the hold coil 40. In other words, the shift coil 30 and hold coil 40 do not overlap along their axes. This arrangement allows for a simple manufacturing process for each coil separate from the manufacture process of the other coil.

In an alternative embodiment, the shift coil 30 is disposed partially or completely around the hold coil 40 as shown in FIG. 2B. In other words, the shift coil 30 and the hold coil 40 overlap along their axes. This nested arrangement provides a beneficial reduction in overall size required for the solenoid 20. Additionally, the rod 25 can be made shorter, and therefore will typically weigh less than rods used with coils that do not overlap. This reduction in size and weight of the rod 25 allows the solenoid 20 to operate with a shorter response time.

J As discussed above, if a biasing member is provided within or is mechanically coupled to the solenoid 20, the amount of force generated by the coils must be greater than the amount of biasing force generated by the spring. Generally, two levels of force are required of the coil. First, the solenoid 20 must generate enough force to shift a plunger from the first position to the second position. The force required to move the plunger from the first position to the second position is called the “shifting” force. Second, the coil must be able to generate enough force to hold the plunger in the second position, for example, against the force generated by a biasing member such as the valve spring 3 or the spring 10. This is called the “holding” force. Generally, the electrical power required to produce the shifting force is greater than the electrical power required to produce the holding force.

The solenoid 20 depicted in FIG. 2 also includes an optional universal voltage input 60 electrically connected to the shift coil 30 and to first and second voltage inputs 65 and 66. The universal voltage input 60 is part of an electric circuit 15 that includes the shift coil 30, hold coil 40, and an electric switch 50 (shown in FIG. 3). The electric switch 50 may be controlled by the timer 55. In other embodiments, the universal voltage input 60 is omitted for simplicity sake, and the appropriate voltage for operation of the shift coil 30 and hold coil 40 is supplied directly to the first and second input leads 65 and 66.

FIG. 2C depicts another embodiment of the invention. In this embodiment, the shift coil 30 is disposed around a first leg 71 of a U-shaped member 70, and the hold coil 40 is disposed around a second leg 72 of the U-shaped member 70. Typically, the U-shaped member is made of a material such as iron or steel that responds to magnetic force. The legs of the U-shaped member help focus the magnetic field created by the shift coil 30 and hold coil 40. The movable member in this embodiment is a movable bar 25′ that pivots relative to the U-shaped member 70. The movable bar 25′ can pivot around a hinge or bend position, for example. In one application, the solenoid 20 in this embodiment is connected to a valve and blocks an air passage upon actuation. In another application, the solenoid 20 opens or closes an electrical switch upon actuation.

FIG. 3 schematically represents the electric circuit 15 used in the solenoid 20. As shown in FIG. 3, the solenoid 20 includes a first electrical input 65 and second electrical input 66. These electrical inputs can be free wires extending from the solenoid and internally connected to the solenoid. In an alternative embodiment, the first and second electric inputs can be terminals on the solenoid 20, for example.

In the example shown in FIG. 3, the first and second electrical inputs are connected to a universal voltage input 60, which converts an input voltage to a voltage appropriate to operate a shift coil 30 and a hold coil 40. For example, the universal voltage input 60 may be configured to convert 120 and/or 240 VAC, into 6 VDC. Additionally, the universal voltage input 60 may be configured to convert 12 and/or 24 VDC into 6 VDC.

As further shown in FIGS. 3 and 4, an electric switch 50 is disposed in the electric circuit 15 between the shift coil 30 and the hold coil 40. In FIG. 3, the electric switch 50 is in a first state. In FIG. 4, the electric switch 50 is in a second state. The electric switch 50 is used to connect or disconnect the two coils at the appropriate time. An optional timer 55 may be included in or on the solenoid 20 in order to delay the change of state of the electric switch 50. For example, when the solenoid 20 receives an activation signal or is first energized from an external source such as a relay, current will flow through the shift coil 30 to develop a magnetic field creating a shifting force sufficient to move a rod disposed within or around the shift coil 30. At this time, the electric switch 50 is in a first state, and a relatively high electric current flows through the shift coil 30, preferably from 50 to 200 mA, more preferably around 80-100 mA. After a predetermined delay controlled by the timer 55, the electric switch 50 will change from a first state, in which the hold coil 40 is not connected in series with the shift coil 30, to a second state, in which the hold coil 40 is connected in series with the shift coil 30 as shown in FIG. 4. The time delay for switching the electric switch from the first state to the second state is preferably in the range of 5 milliseconds to 500 milliseconds, but other times are possible. When the timer 55 activates the hold coil 40 within this time range, the shift coil 30 has sufficient time to shift the rod 25, but does not unnecessarily waste energy and generate heat. In one example, the timer 55 is a circuit including a resistor and capacitor. The capacitor requires a certain period of time in order to charge up. Once the capacitor is charged, then the electric switch 50 changes state.

In another variation, the timer 55 may be omitted, and the electric switch 50 will change state in direct response to the movement of the rod 25. For example, once the rod has moved in response to movement of the shift coil 30, the rod 25 may complete an electrical circuit. One benefit of this arrangement is that the hold coil 40 will not reduce the amount of current flowing through the shift coil 30 prematurely. In other words, it is preferable for the solenoid 20 to produce the shifting force until the rod 25 has reached its desired position. It is preferable for the solenoid 20 to change to the holding force after the rod 25 has reached its desired position.

One benefit of the series arrangement for the shift coil 30 and hold coil 40 shown in FIG. 4 is that the hold coil 40 can act in concert with the shift coil 30 while also functioning as an added resistor or impedance device. In other words, during actuation of the solenoid 20, the amount of current flowing through the shift coil 30 and hold coil 40 while the shift and hold coils are connected in series will be less than the amount of current flowing through the shift coil 30 when the hold coil 40 is in a disconnected state. Therefore, assuming the voltage applied to the electric circuit 15 is constant, the amount of power consumed by the solenoid 20 will be less when the hold coil 40 is connected in series with the shift coil 30 than when the shift coil 30 is connected in the electric circuit 15 without the hold coil 40. In other words, less power is consumed when the holding force is generated than when the shifting force is generated. Therefore, the solenoid 20 is more energy efficient than conventional solenoids because, as discussed above, the electrical power required to produce the holding force is typically lower than the electrical power required to produce the shifting force. Thus, it is appropriate for the solenoid 20 to use less energy when only the holding force is required.

In one example of the invention, the wire used to create the shift coil 30 is wrapped with fewer “turns” than the number of turns used to create the hold coil 40. For example, the shift coil 30 may have only one tenth as many turns as the hold coil 40 has. One benefit of this arrangement is that the shift coil 30 can produce a large magnetic field due to high current, but takes up relatively little space. Additionally, the wire used to form the shift coil 30 may be larger in diameter than the wire used in the hold coil 40. In one example, the shift coil 30 includes 36 gauge wire, and the hold coil 40 includes 44 gauge wire. However, other gauges of wire are sometimes used for either of the coils.

The shift coil 30 typically has a lower impedance than the hold coil 40 due to the larger gauge wire and fewer turns used in the shift coil 30. For example, the shift coil 30 may have a total impedance (or resistance in the case of pure DC voltage) of 75Ω. In contrast, the hold coil 40 may have a total impedance of 2000Ω. Therefore, the overall current used by the electric circuit 15 is lower when the hold coil 40 is placed in series with the shift coil 30 than when the hold coil 40 is omitted from the electric circuit 15. Thus, the overall energy used by the electric circuit 15 is less when the solenoid 20 is in the holding state. For example, if the voltage applied to the electric circuit 15 is 6 VDC and only the shift coil 30, measured at a resistance of 75Ω, provides any significant impedance (resistance), then the current flowing through the electric circuit 15 will be 6 VDC/75Ω=80 mA, and total power consumption will be 480 mw. After the electric switch 50 changes state to include the hold coil 40 in the electric circuit 15, total current will be 6 VDC/(75+2000)Ω=2.89 mA, and total power consumption will be 17.3 mW.

Accordingly, power consumption during the shift operation, i.e., when the shift coil 30 receives current, but the hold coil 40 does not, is approximately 500 mW. When the holding coil 40 is energized and the solenoid 20 generates the holding force, the power consumption is approximately 20 mW. Thus, by adding the hold coil 40 to the electric circuit 15 in series with the shift coil 30, the power consumption of the solenoid 20 during the holding state is significantly lower than during the shifting state. An additional benefit of the reduction in power consumption is the corresponding reduction in heat produced by the solenoid 20 during the holding state.

Even though less current flows through the shift coil 30 and the hold coil 40 while the electric switch 50 is in the second state, the holding force generated by the shift coil 30 and hold coil 40 is sufficient to maintain the rod 25 in the second position.

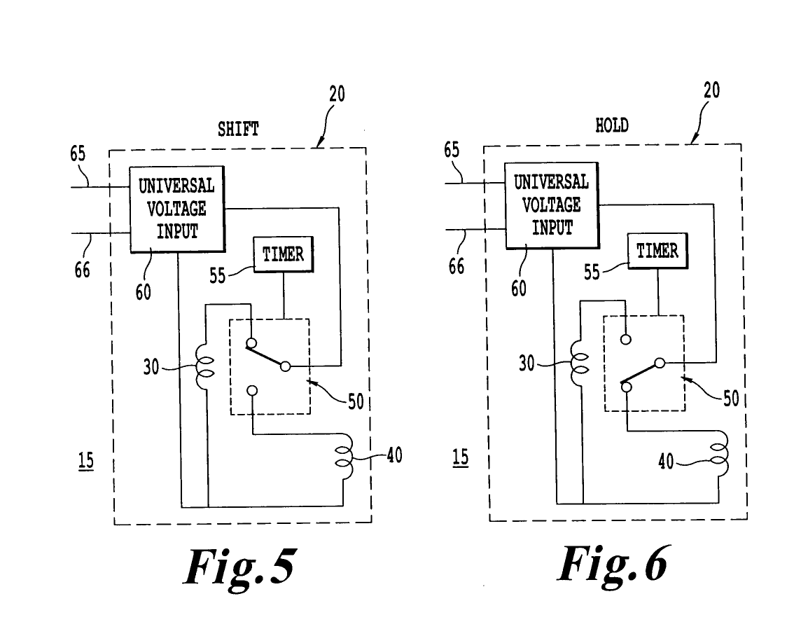

In another embodiment, shown in FIGS. 5 and 6, the shift coil 30 and hold coil 40 are used independently. Once the shift coil 30 causes the rod 25 to shift, the hold coil 40 receives all the electric current, and the shift coil 30 receives none. FIG. 5 shows the shifting state. FIG. 6 shows the holding state.

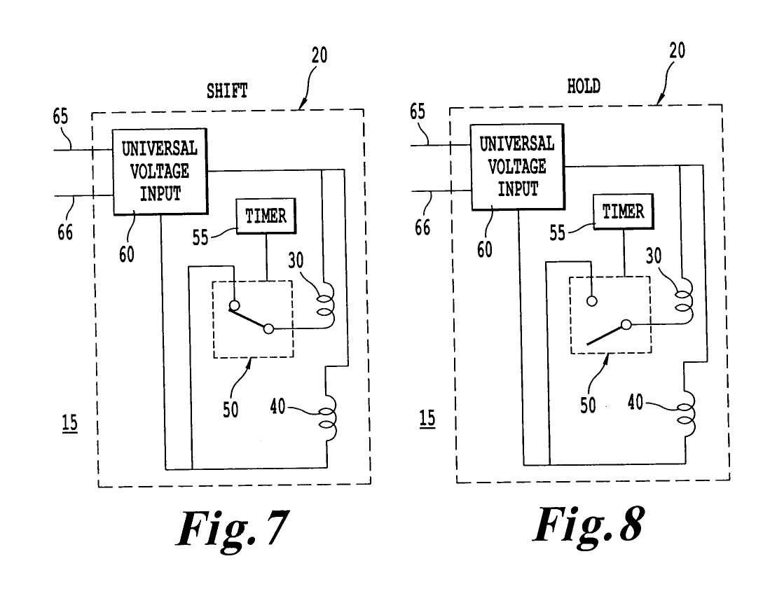

In another embodiment, shown in FIGS. 7 and 8, the shift coil 30 and hold coil 40 are in parallel, but both receive electric current during the shifting state and only one receives current in the holding state. During the holding state, only the hold coil 40 receives current. FIG. 7 shows the shift state. FIG. 8 shows the hold state.

Although the description above contains many specifics, these should not be construed as limiting the scope of the invention but as merely providing illustrations of some of the presently preferred embodiments of this invention. Thus the scope of the invention should be determined by the appended claims and their legal equivalents, rather than by the examples given. From the foregoing, it can be seen that the present invention provides at least some contribution to the field.

1. A solenoid actuator comprising:
an electric circuit including
a first power input terminal,
a second power input terminal,
a first coil wound around a first axis and configured to generate a first magnetic field while electric current flows through the first coil,
a second coil wound around a second axis and configured to generate a second magnetic field while electric current flows through the second coil,
an electric switch configured to switch from a first state in which the first coil is connected in series with the first and second power input terminals without being connected in series with the second coil, to a second state in which the first coil is connected in series with the second coil; and
a movable member influenced by the first and second magnetic fields generated by the first coil and the second coil and configured to move with respect to the first and second coils from a first position to a second position in response to the magnetic field generated by the first coil.

2. The solenoid actuator according to claim 1, further comprising a biasing member that biases the movable member toward the first position.

3. The solenoid actuator according to claim 2, further comprising a valve spool mechanically coupled to the movable member.

4. The solenoid actuator according to claim 3, wherein the valve spool is disposed in a fluid passageway of a valve and opens and closes the passageway in response to movement of the movable member.

5. The solenoid actuator according to claim 4, wherein the electric circuit further comprises a universal voltage input connected in series with the first coil.

6. The solenoid actuator according to claim 1, wherein the electric circuit further comprises a universal voltage input connected in series with the first coil.

7. The solenoid actuator according to claim 1, wherein the first coil has a lower electrical impedance than the second coil.

8. The solenoid actuator according to claim 1, wherein the electric circuit has a higher impedance while the electric switch is in the second state than when the electric switch is in the first state.

9. The solenoid actuator according to claim 1, wherein the first coil includes a wire of larger gauge than a gauge of wire used in the second coil.

10. The solenoid actuator according to claim 9, wherein the first coil includes fewer turns than the second coil.

11. The solenoid actuator according to claim 1, further comprising a timer connected to the electric switch and that controls actuation of the electric switch such that the second coil becomes energized a predetermined time after the first coil becomes energized.

12. The solenoid actuator according to claim 11, wherein the predetermined time is from 5 to 500 milliseconds.

13. An automatic valve comprising:
a spring-actuated valve;
a solenoid disposed within the spring-actuated valve;
an electric circuit including
a first power input terminal,
a second power input terminal,
a first coil wound around a first axis and configured to generate a first magnetic field while electric current flows through the first coil,
a second coil wound around a second axis and configured to generate a second magnetic field while electric current flows through the second coil,
an electric switch configured to switch from a first state in which the first coil is connected in series with the first and second power input terminals without being connected in series with the second coil, to a second state in which the first coil is connected in series with the second coil,
means for controlling time at which the electric switch changes state; and
a movable member influenced by the first and second magnetic fields generated by the first coil and the second coil and configured to move with respect to the first and second coils from a first position to a second position in response to the magnetic field generated by the first coil.

14. The automatic valve according to claim 13, further comprising a biasing member that biases the movable member toward the first position.

15. The automatic valve according to claim 14, further comprising a valve spool mechanically coupled to the movable member.

16. The automatic valve according to claim 15, wherein the valve spool is disposed in a fluid passageway of a valve and opens and closes the passageway in response to movement of the movable member.

17. The automatic valve according to claim 16, wherein the electric circuit further comprises a universal voltage input connected in series with the first coil.

18. The automatic valve according to claim 13, wherein the electric circuit further comprises a universal voltage input connected in series with the first coil.

19. The automatic valve according to claim 13, wherein the first coil has a lower electrical impedance than the second coil.

20. The automatic valve according to claim 13, wherein the electric circuit has a higher impedance while the switch is in the second state than when the electric circuit is in the first state.

21. The automatic valve according to claim 13, wherein the first coil includes a wire of larger gauge than a gauge of wire used in the second coil.

22. The automatic valve according to claim 21, wherein the first coil includes fewer turns than the second coil.

23. A method of actuating a solenoid comprising:
providing a first coil;
providing a second coil;
electrifying the first coil with a first electric current such that a first magnetic field generated by the first coil during electrification moves the movable member from a first position to a second position;
changing a state of a switch connected between the first coil and second coil such that a second electric current, different from the first electric current, flows in series connection through the first and second coils and generates a second magnetic field in the second coil that holds the movable member in the second position.

24. A solenoid actuator comprising:
an electric circuit including
a first power input terminal,
a second power input terminal,
a first coil wound around a first axis and configured to generate a first magnetic field while electric current flows through the first coil,
a second coil wound around a second axis and configured to generate a second magnetic field while electric current flows through the second coil,
an electric switch configured to switch from a first state in which the first coil is connected in series with the first and second power input terminals and the second coil is not connected in series with the first and second power input terminals, to a second state in which the first coil is not connected in series with the first and second power input terminals and the second coil is connected in series with the first and second power input terminals; and
a movable member influenced by the first and second magnetic fields generated by the first coil and the second coil and configured to move with respect to the first and second coils from a first position to a second position in response to the magnetic field generated by the first coil and further configured to remain in the second position while the electric switch is in the second state.

25. A solenoid actuator comprising:
an electric circuit including
a first power input terminal,
a second power input terminal,
a first coil wound around a first axis and configured to generate a first magnetic field while electric current flows through the first coil,
a second coil wound around a second axis and configured to generate a second magnetic field while electric current flows through the second coil,
an electric switch configured to switch from a first state in which the first coil and second coil are connected in parallel with each other and connected in series with the first and second power input terminals, to a second state in which the first coil is not connected in series with the first and second power input terminals and the second coil remains connected in series with the first and second power input terminals; and
a movable member influenced by the first and second magnetic fields generated by the first coil and the second coil and configured to move with respect to the first and second coils from a first position to a second position in response to the magnetic field generated by the first coil and by the second coil and configured to remain in the second position while the electric switch is in the second state.
